(19) United States
(12) Patent Application Publication
(10) Pub. No.: US 2010/0103802 A1
(43) Pub. Date: Apr. 29, 2010

(54) OPTICAL UNIT AND ELECTRONIC EQUIPMENT USING THE SAME

(75) Inventors: Masaya TATEYANAGI, Shiga (JP); Shinichi IJIMA, Osaka (JP); Masanori MINAMIO, Osaka (JP); Shogo HORINOUCHI, Fukuoka (JP)

Correspondence Address: PANASONIC PATENT CENTER, 1130 CONNECTICUT AVENUE NW, SUITE 1100, WASHINGTON, DC, 20036, US

(73) Assignee: PANASONIC CORPORATION, Osaka (JP)

(21) Appl. No.: 12/571,778

(22) Filed: Oct. 1, 2009

(30) Foreign Application Priority Data
Oct. 24, 2008 (JP) 2008-274315

(51) Int. Cl. G11B 7/125; G02B 27/12; G11B 7/135

(52) U.S. Cl. 369/112.24; 359/640; 369/112.28; G9B/7.098; G9B/7.112

(57) ABSTRACT

An optical unit includes: a first light emitting device configured to emit a first beam; and a second light emitting device configured to emit a second beam in a direction the same as a direction of the first beam where the second beam is different in wavelength from the first beam. An emission surface of the second light emitting device is arranged at a distance from an emission surface of the first light emitting device in an opposite direction to the direction of the first beam.

### CROSS-REFERENCE TO RELATED APPLICATION

This application claims priority to Japanese Patent Application No. 2008-274315 filed on Oct. 24, 2008, the disclosure of which including the specification, the drawings, and the claims is hereby incorporated by reference in its entirety.

### BACKGROUND

The present disclosure relates to optical units and electronic equipment using the same, for example, electronic equipment configured to read or write information from or to media such as Compact Discs (CDs), Digital Versatile Discs (DVDs), Blu-ray Discs (BDs), and the like.

Conventionally, electronic equipment including optical units to read and write information from and to media such as CDs, DVDs, BDs, and the like has, for example, the following structure.

That is, the electronic equipment is structured such that a first beam emitted from a first light emitting device for CD and DVD sequentially pass through an aberration correcting lens, a first objective lens, and the like, and then the first beam forms an image on a track of a medium. Moreover, the electronic equipment is structured such that a second beam emitted from a second light emitting device for BD sequentially passes through the aberration correcting lens, a second objective lens, and the like, and then forms an image on a track of a medium. It should be noted that a structure in which a beam passes through a relay lens prior to passing through an aberration correcting lens may be possible.

Such a configuration is disclosed in, for example, Japanese Unexamined Patent Publication No. 2006-120283 (Patent Document 1).

### SUMMARY

However, the above technique achieves downsizing only with difficulty.

In the example mentioned above, the first light emitting device emits a beam having a wavelength of 780 nm for CD and a beam having a wavelength of 650 nm for DVD. Moreover, the second light emitting device emits a beam having a wavelength of 405 nm for BD.

Thus, the wavelength of the beam for DVD is shorter than the wavelength of the beam for CD, and further, the wavelength of the beam for BD is shorter than the wavelength of the beam for DVD. Therefore, an image formed on a track of a medium serving as a DVD can be smaller than an image formed on a track of a medium serving as a CD, and an image formed on a track of a medium serving as a BD can be smaller than the image formed on the track of the medium serving as the DVD. Accordingly, the recording density of the DVD is higher than the recording density of the CD, and the recording density of the BD is higher than the recording density of the DVD.

Here, a two-wavelength light emitting device configured to emit a beam for CD and a beam for DVD is known. Therefore, electronic equipment supporting all of CDs, DVDs, and BDs includes both an optical unit having a light emitting device for CD and DVD and an optical unit having a light emitting device for BD.

Since conventional electronic equipment includes two optical units as described above, downsizing of the conventional electronic equipment is limited.

Moreover, for electronic equipment configured to read from and write to media such as CDs and the like, it is sought to improve the quality of reproduction and recording, for example, to reduce noise, to improve resolution, and the like.

In view of the problems discussed above, a technique to downsize optical units and electronic equipment using the same and a technique to improve the quality of reproduction and recording will be described.

First, the applicants of the present application conducted the studies as follows.

As described above, electronic equipment supporting all of CDs, DVDs, and BDs includes two optical units. This is because a light emitting device for CD and DVD and a light emitting device for BD use different materials and the like, and thus are separate devices, so that it is general to provide an optical unit on which the light emitting device for CD and DVD is to be mounted and an optical unit on which the light emitting device for BD is to be mounted.

In contrast, if it is assumed that both a light emitting device for CD and DVD and a light emitting device for BD are mounted on a single optical unit, a distance between their light emitting points poses a problem.

A beam emitted from each light emitting device passes through an optical system including various types of lenses, prisms, and the like, and forms an image on a medium. Here, it is desirable that optical axes of three beams for CD, DVD, and BD emitted from the optical unit are coincident with one another. Further, it is desirable that an optical path length from an emission surface of the light emitting device for CD and DVD to an emission surface of the optical unit is equal to an optical path length from an emission surface of the light emitting device for BD to the emission surface of the optical unit. In this way, for the beams for CD, DVD, and BD, apparent light emitting points of the optical unit can be made coincident with each other to use a common optical system in electronic equipment, which leads to a desirable configuration as electronic equipment.

Here, if a plurality of light emitting devices are respectively mounted on separate optical units, the approach of, for example, providing predetermined optical systems respectively for beams from the light emitting devices enables optical axes and optical path lengths of the beams to be adjusted relatively easily.

However, if a plurality of light emitting devices is mounted on one optical unit, the distance between light emitting points of the light emitting devices is short, which makes it difficult to adjust beams from the light emitting points by using separate lenses or the like. In connection with this, since each light emitting device has a certain size, the light emitting points cannot be located close enough to each other to be able to consider the beams emitted from the light emitting devices as having the same optical axis.

Next, as one of causes degrading the quality of reproduction and recording of electronic equipment configured to read from and write to media such as CDs and the like, the fact that an image formed on a medium by a beam emitted from a light emitting device is elliptical was studied. It is presumed that if a beam forms an elliptical image elongated parallel to a track of a medium, the beam may fall on not only a signal in a targeted location but also a neighboring signal and the like, which may cause an error. Further, it is presumed that if a beam forms an elliptical image elongated perpendicularly to a track of a medium, the beam may fall on not only a targeted track but also a neighboring track, which may cause an error.

Based on the studies described above, a first optical unit of the present disclosure includes: a first light emitting device configured to emit a first beam, and a second light emitting device configured to emit a second beam in a direction the same as a direction of the first beam where the second beam is different in wavelength from the first beam, wherein an emission surface of the second light emitting device is arranged at a predetermined distance from an emission surface of the first light emitting device in an opposite direction to the direction of the first beam.

In such an optical unit, the light emitting surface of the second light emitting device is set back a predetermined distance from the light emitting surface of the first light emitting device (in an opposite side of a direction in which the beams are emitted). In this way, the optical path length of the first beam and the optical path length of the second beam are previously made different from each other by a predetermined length to correct an optical path length resulting from making optical axes of the two beams coincident to each other. Therefore, the optical path lengths are eventually the same.

It should be noted that the predetermined distance is preferably set in accordance with a distance between a light emitting point of the first light emitting device and a light emitting point of the second light emitting device.

The difference in optical path length resulting from making the optical axes of the first beam and the second beam coincident with each other depends on the distance between the two light emitting points. Thus, in accordance with the distance between the two light emitting points, the predetermined distance should be set.

Moreover, it is preferable that the optical unit further includes: a prism for optical coupling to make an optical axis of the first beam and an optical axis of the second beam coincident with each other, wherein the predetermined distance is set such that an optical path length for the first beam to arrive at a point where the first beam is output from the prism for optical coupling is substantially equal to an optical path length for the second beam to arrive at a point where the second beam is output from the prism for optical coupling.

With this configuration, when the first beam and the second beam are emitted from the optical unit, the optical axis of the two beams are coincident with each other, and the optical path lengths from the light emitting points are equal to each other. This is a desirable configuration as an output unit configured to emit a plurality of beams.

Moreover, it is preferable that a height of a light emitting point of the first light emitting device is equal to a height of a light emitting point of the second light emitting device.

With this configuration, the optical unit dispenses with the need for adjusting the optical axes in regard to the height direction, and thus it is possible to simplify the configuration of, for example, the prism for optical coupling used to make the optical axes coincident with each other.

A second optical unit comprising of the present disclosure includes: a first light emitting device configured to emit a first beam; and a second light emitting device configured to emit a second beam in a direction the same as a direction of the first beam where the second beam is different in wavelength from the first beam, wherein a height of a light emitting point of the first light emitting device is equal to a height of a light emitting point of the second light emitting device.

With the second optical unit, the first beam and the second beam are emitted from the optical unit at the same height without necessitating adjustment using a prism and the like. Therefore, it is possible to ease, for example, the configuration of and the adjustment by, for example, the prism for optical coupling which is provided to make the optical axes of the first beam and the second beam coincident with each other. That is, it may be required only that the optical axes are adjusted only in a direction perpendicular to the height direction.

It should be noted that a distance from a predetermined base plane of the optical unit to the light emitting point of the first light emitting device is preferably equal to a distance from the base plane to the light emitting point of the second light emitting device. Moreover, the base plane is preferably a mounting surface used to mount the optical unit.

In this way, as the heights of the light emitting points, the distance from the base plane of the optical unit can be used. Moreover, when the mounting surface used to mount the optical unit on electronic equipment or the like is used as the base plane, the heights of the two light emitting points can be made equal to each other with respect to the electronic equipment or the like.

A third optical unit of the present disclosure includes a first light emitting device configured to emit a first beam, wherein the first light emitting device is mounted obliquely with respect to a predetermined base plane of the optical unit. Here, the base plane is preferably a mounting surface used to mount the optical unit. Moreover, it is preferable that the optical unit further includes a second light emitting device configured to emit a second beam in a direction the same as a direction of the first beam where the second beam is different in wavelength from the first beam.

With such an optical unit, a beam emitted from the light emitting device can easily form an image obliquely with respect to a track of a medium. This can prevent the beam forming the image from falling also on a neighboring track, and a neighboring signal of a predetermined signal from being erroneously read at the same time with the predetermined signal in the same track. Therefore, it is possible to improve the quality of reproduction and recording.

Moreover, it is preferable that the optical unit further includes a prism for optical coupling to make an optical axis of the first beam and an optical axis of the second beam coincident with each other.

With this configuration, it is possible to obtain an optical unit which outputs a first beam and a second beam having the same optical axis.

Moreover, it is preferable that in the first optical unit or the second optical unit, at least one of the first light emitting device and the second light emitting device is mounted obliquely with respect to a predetermined base plane of the optical unit. The base plane is preferably a mounting surface used to mount the optical unit on electronic equipment or the like.

With this configuration, a beam emitted from a light emitting device mounted obliquely with respect to the base plane (e.g., the mounting surface) can form an image obliquely with respect to a track of a medium. This can prevent the beam forming the image from falling also on a neighboring track, and a neighboring signal of a predetermined signal from being erroneously read at the same time with the predetermined signal in the same track. Therefore, it is possible to improve the quality of reproduction and recording.

Moreover, it is preferable that the first optical unit or the second optical unit further includes: a mount at least having a first inclined plane and a second inclined plane, wherein the first light emitting device is provided on the first inclined plane of the mount, and the second light emitting device is provided on the second inclined plane of the mount.

Moreover, it is preferable that the mount is of triangular-prism shape, and one of three side surfaces of the triangular-prism-shaped mount is a body attachment surface, and the other two side surfaces are the first inclined plane and the second inclined plane.

With this configuration, heat generated by the first light emitting device and the second light emitting device can be lead through the mount and effectively dissipated through the body attachment surface. Moreover, since the first light emitting device and the second light emitting device are respectively mounted on the first inclined plane and the second inclined plane, the first beam and the second beam each can form an image obliquely with respect to a track of a medium. Therefore, it is possible to improve the quality of reproduction and recording.

Moreover, it is preferable that the triangular-prism-shaped mount has a fourth side surface as if at least part of a ridge formed by the meeting of the first inclined plane and the second inclined plane is removed, and the fourth side surface is a ground connection surface. The ground connection surface may be provided in this way.

Moreover, it is preferable that the first light emitting device selectively emits beams of two wavelengths.

Moreover, it is preferable that the first light emitting device emits a beam for CD and a beam for DVD.

Moreover, it is preferable that the second light emitting device output a beam for BD.

With this configuration, the optical unit can emit beams respectively supporting different media such as a CD, a DVD, and a BD.

Electronic equipment of the present disclosure includes: any one of the optical units of the present disclosure; a first objective lens for the first light emitting device; and a second objective lens for the second light emitting device, wherein the first objective lens and the second objective lens are provided in a light emission direction of the optical unit.

Using the optical unit of the present disclosure makes it possible to achieve electronic equipment using a plurality of beams (e.g., beams for CD, DVD, and BD) without a plurality of optical units being mounted. Moreover, of course, providing a plurality of optical systems corresponding to the plurality of optical units is no longer necessary. Therefore, the electronic equipment can be downsized.

It should be noted that the electronic equipment preferably further includes a prism for optical coupling to make an optical axis of the first beam and an optical axis of the second beam coincident with each other.

Moreover, it is preferable that the electronic equipment further includes a relay lens provided in the light emission direction of the optical unit.

Moreover, it is preferable that the electronic equipment further includes an aberration correcting lens between the relay lens and the first and second objective lenses.

The components mentioned above may be provided as needed.

Moreover, it is preferable that at least one of the first beam passed through the first objective lens and the second beam passed through the second objective lens forms an image obliquely with respect to a track of a media arranged to face the first objective lens and the second objective lens.

This can prevent the beam forming the image from falling also on a neighboring track, and a neighboring signal of a predetermined signal from being erroneously read at the same time with the predetermined signal in the same track. Therefore, it is possible to improve the quality of reproduction and recording.

Moreover, second electronic equipment of the present disclosure includes: the third optical unit of the present disclosure; an objective lens for the light emitting device where the objective lens is provided in a light emission direction of the optical unit, wherein a beam emitted from the light emitting device forms an image obliquely with respect to a track of a medium arranged to face the objective lens.

Moreover, it is preferable that the image is elliptical, and an angle formed between a major axis of the elliptical image and the track is greater than or equal to 20° and less than or equal to 50°.

With such an elliptical image forming the above angle, it is possible to more reliably obtain the advantage of improving the quality of reproduction and recording.

With the optical unit and the electronic equipment including the same described above, it is possible to provide a plurality of beams from one optical unit, and thus the optical unit and the electronic equipment can be downsized. Moreover, since a beam forms an image obliquely with respect to a track of a medium, it is possible to read and write more accurately.

### BRIEF DESCRIPTION OF THE DRAWINGS

FIG. 1 is a view showing an optical circuit in example electronic equipment of an embodiment of the present disclosure.

FIG. 2 is a perspective view of an example optical unit of the embodiment.

FIG. 3 is a front view of the example optical unit of the embodiment.

FIG. 4 is an enlarged front view of a major portion of the example optical unit of the embodiment.

FIG. 5 is a schematic view showing the positional relationship between an emission surface of a first light emitting device and an emission surface of a second light emitting device in the example optical unit of the embodiment.

FIG. 6 is a view illustrating a medium and an image formed thereon by a beam according to the embodiment.

FIG. 7 is a view illustrating an example optical unit of an embodiment.

FIGS. 8A through 8C are views each illustrating the disposition of optical devices of an example optical unit of an embodiment.

FIG. 9 is a view showing an example electronic equipment of an embodiment provided with a relay lens.

### DETAILED DESCRIPTION

Hereinafter, an embodiment of the present disclosure will be described with reference to the drawings. FIG. 1 is a view schematically showing configurations of an example optical unit and example electronic equipment of the present embodiment capable of writing to and reading from media respectively serving as a CD, a DVD, and a BD.

In FIG. 1, an optical unit 1 includes a first light emitting device 2 capable of emitting beams of two wavelengths for CD and DVD, and a second light emitting device 3 for BD. The configuration of the optical unit 1 will be described later in detail.

In an emission direction in which the first light emitting device 2 and the second light emitting device 3 of the optical unit 1 emit beams, a prism 4 for optical coupling, an aberration correcting lens 6, a long-wave light reflector 7, and a short-wave beam reflector 8 are linearly arranged in this order from an optical unit 1 side. It should be noted that here, the optical unit 1 and the prism 4 for optical coupling are separately provided in the electronic equipment. However, an optical unit may include a prism for optical coupling, and such an optical unit may be mounted on electronic equipment (that is, the optical unit 1 together with the prism 4 for optical coupling may be considered as an optical unit 1b indicated by a broken line in FIG. 1).

Moreover, in a reflection direction of the long-wave light reflector 7, a first objective lens 10 is provided such that a reflected beam enters the first objective lens 10 through an optical member 9 having a filter function. Furthermore, in a reflection direction of the short-wave beam reflector 8, a second objective lens 12 is provided such that a reflected beam enters the second objective lens 12 through an achromatic diffractive lens 11. It should be noted that the functions of the optical member 9 and the achromatic diffractive lens 11 are as described in Patent Document 1, and the like, and thus are not described in detail here.

The beam passed through the first objective lens or the second objective lens forms an image on a medium 13 arranged to face the objective lens. Here, the discoid medium 13 serving as any one of a CD, a DVD, and a BD is shown as one medium 13 for the sake of illustration and description. However, in practice, any one of a CD, a DVD, and a BD is selectively arranged as shown in FIG. 1. Moreover, as to the medium 13 of FIG. 1, a track for CD is shown on the uppermost side of the figure (on a side far from the first objective lens 10 and the like), a track for BD is shown on the lowermost side, and a track for DVD is shown between the track for CD and the track for BD.

Moreover, the aberration correcting lens 6 is configured such that a lead screw 6b is rotated by using a stepping motor 6a to move the aberration correcting lens 6 backward and forward for correcting aberration.

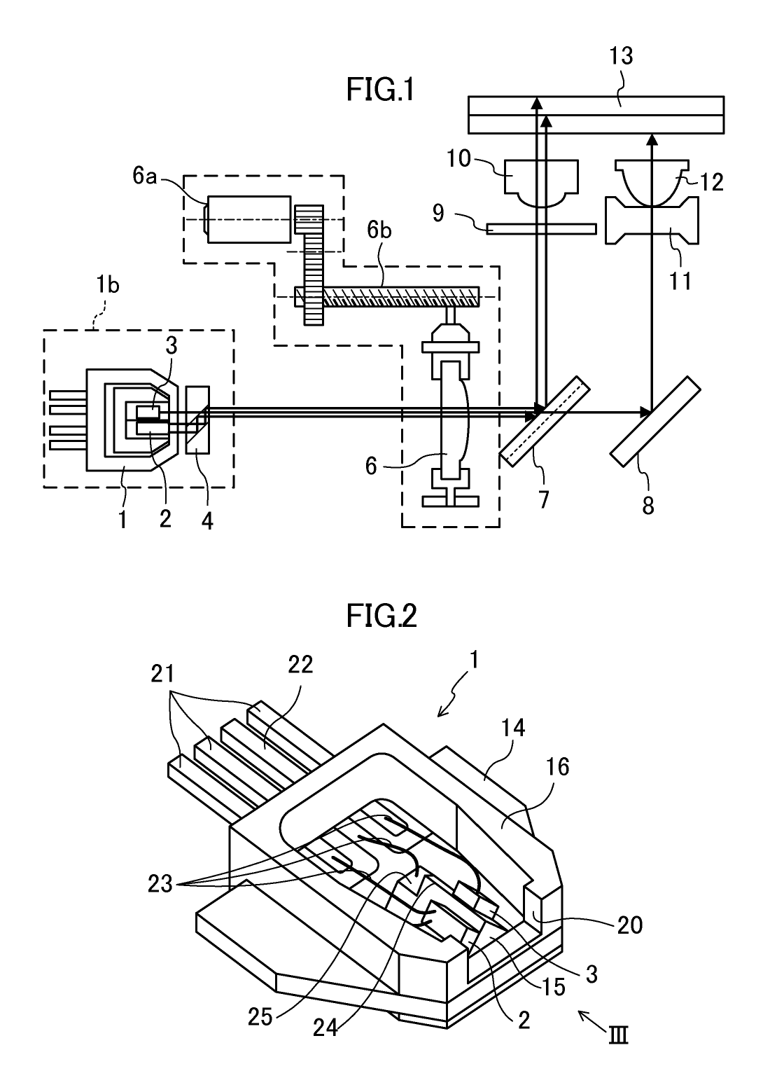

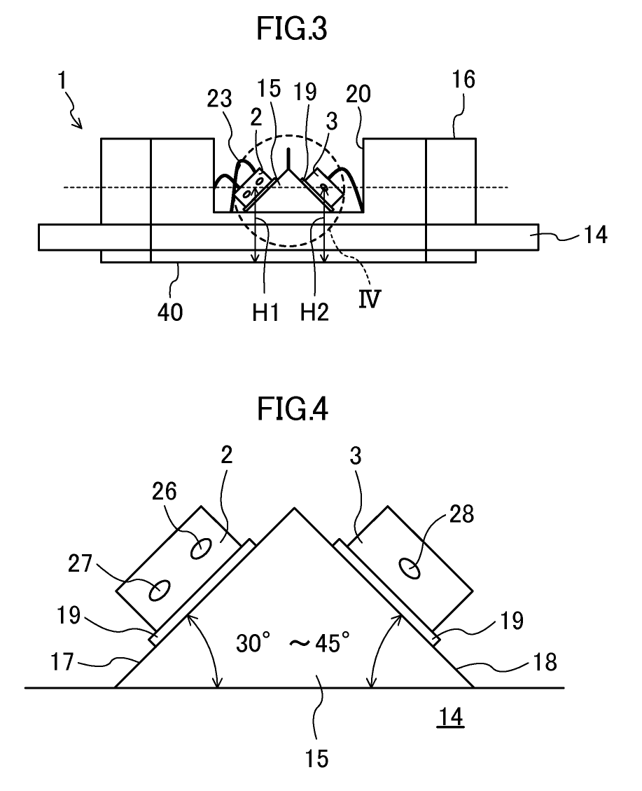

Next, the optical unit 1 will be further described. FIG. 2 is a perspective view showing the configuration of the optical unit 1. Moreover, FIG. 3 is a view of the optical unit 1 viewed in the direction III of FIG. 2 (i.e., viewed in a light emission direction). FIG. 4 is an enlarged view of the area IV of FIG. 3. In FIG. 4, a mount 15, and the first light emitting device 2 and the second light emitting device 3 mounted on the mount 15 are shown.

As shown in FIG. 2, the optical unit 1 includes a trapezoidal heat dissipation plate 14, a triangular-prism-shaped mount 15 installed on the heat dissipation plate 14, and a circumference protection wall 16 made of, for example, a resin surrounding the triangular-prism-shaped mount 15.

More specifically, one of three side surfaces of the triangular-prism-shaped mount 15 made of a metal is a body attachment surface. The body attachment surface (e.g., the lower surface) may be directly adhered to the heat dissipation plate 14, or may be connected via a heat transfer member to the heat dissipation plate 14. In this way, heat generated from the first light emitting device 2 for CD and DVD and the second light emitting device 3 for BD is efficiently transferred through the mount 15 to the heat dissipation plate 14.

Moreover, as shown in FIG. 4, two side surfaces of the three side surfaces of the triangular-prism-shaped mount, except the body attachment surface connected to the heat dissipation plate 14, are an inclined plane 17 and an inclined plane 18 each forming an angle of 30° to 45° with respect to the body attachment surface. Here, the first light emitting device 2 is adhered and fixed on the inclined plane 17, and the second light emitting device 3 is adhered and fixed on the inclined plane 18 respectively through die bonding materials 19. Furthermore, a ground connection surface 25 parallel to the body attachment surface is provided as if part of the mount 15 near a back end of a ridge 24 formed by the meeting of the inclined plane 17 and the inclined plane 18 is removed (FIG. 2).

A front side (a side close to the prism 4 for optical coupling in FIG. 1) of the circumference protection wall 16 is provided with an emission window 20 through which beams emitted from the first light emitting device 2 and the second light emitting device 3 go out.

Moreover, from a back section in an interior surrounded by the circumference protection wall 16 to the back of the optical unit 1, input leads 21 and a ground lead 22 are drawn out.

Further, in the interior surrounded by the circumference protection wall 16, two of the input leads 21 are electrically connected via metal fine wires 23 respectively to the first light emitting device 2 and the second light emitting device 3. Furthermore, likewise, in the interior surrounded by the circumference protection wall 16, the ground lead 22 is electrically connected via a metal fine wire 23 to the ground connection surface 25.

In the optical unit 1 of the present embodiment, as described above, the first light emitting device 2 for CD and DVD and the second light emitting device 3 for BD are arranged respectively on the inclined plane 17 and the inclined plane 18 of the mount 15. The first light emitting device 2 emits a beam (wavelength: 780 nm) for CD and a beam (wavelength: 650 nm) for DVD respectively through openings 26 and 27 provided on its emission surface 2a (see, for example, FIG. 4). Moreover, the second light emitting device 3 emits a beam (wavelength: 405 nm) for BD through an opening 28 provided on its emission surface 3a in the same direction as that of the beams emitted from the first light emitting device 2.

These beams of three wavelengths (the beam having a wavelength of 780 nm for CD, the beam having a wavelength of 650 nm for DVD, and the beam having a wavelength of 405 nm for BD) are selectively emitted from the optical unit 1. The emission direction is preferably parallel to a lower surface 40 of the optical unit 1. The emitted beams are supplied to the medium 13 through the prism 4 for optical coupling, the aberration correcting lens 6, the long-wave light reflector 7, the short-wave beam reflector 8, and the like as shown also in FIG. 1.

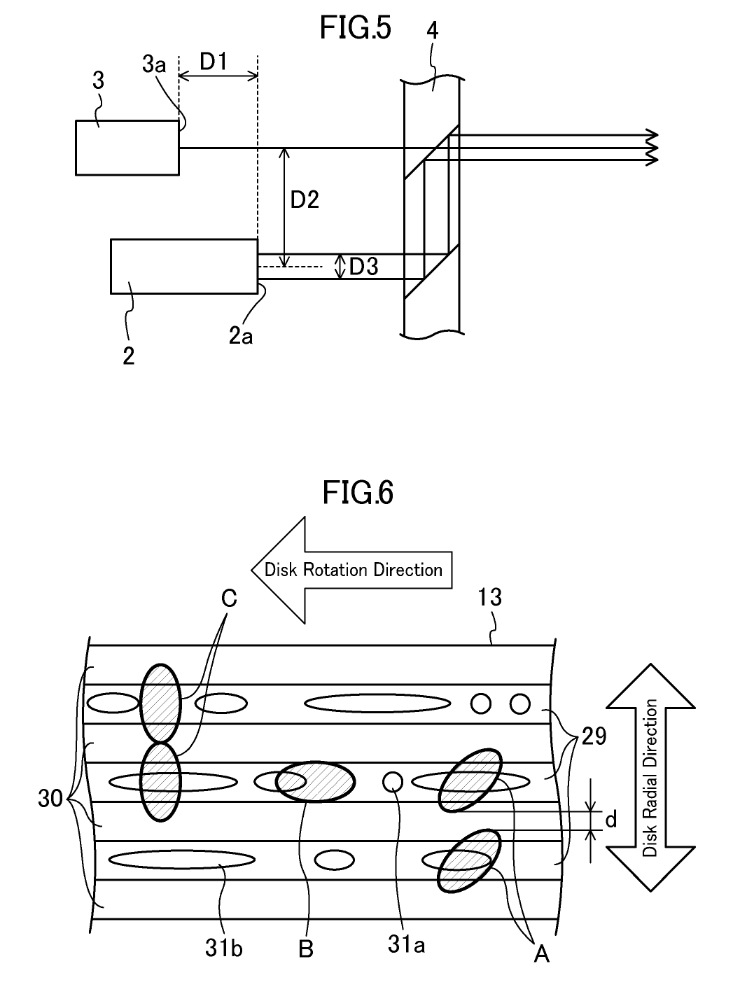

Moreover, it is desirable for the beams of three wavelengths that their optical axes are coincident with one another, and that their optical path lengths are equal to one another. To realize this, as schematically shown in FIG. 5, the emission surface 3a of the second light emitting device 3 is set back a distance D1 from the emission surface 2a of the first light emitting device 2 (in an opposite direction of a direction in which the beams are emitted), and the prism 4 for optical coupling is used to make the optical axes coincident with one another.

Here, a distance D3 between the opening 26 and the opening 27 of the first light emitting device 2 is small enough, and is, for example, 110 μm. Therefore, the optical axes of the beams emitted through the openings can be considered as being coincident with each other. For this reason, the following description is given assuming that the first light emitting device 2 emits a beam at the midpoint between the opening 26 and the opening 27.

On the other hand, a distance D2 between light emitting points (i.e., openings) of the first light emitting device 2 and the second light emitting device 3 is, for example, 800 μm to 1000 μm. This results from, for example, the fact that the first light emitting device 2 and the second light emitting device 3 each have a width of, for example, 300 μm to 400 μm, and that the two light emitting devices have to be mounted with a certain distance therebetween. Such a value of the distance D2 between the light emitting points is too large to consider the optical axes of the beam from the first light emitting device 2 and the beam from the second light emitting device 3 as being coincident with each other. Therefore, the prism 4 for optical coupling is used to make the optical axes of the beams from the light emitting devices coincident with each other. It should be noted that using separate optical systems to process the beams from the light emitting devices is inconvenient, because the value of the distance D2, 800 μm to 1000 μm, is too small. Moreover, a configuration including a plurality of optical systems is disadvantageous for downsizing the electronic equipment.

If the prism 4 for optical coupling is used to refract the beam from the first light emitting device 2 to make its optical axis coincident with the optical axis of the beam from the second light emitting device 3, the travel distance of the beam from the first light emitting device 2 may increase by the distance D2. To correct this, the emission surface 3a of the second light emitting device 3 is set back the distance D1 from the emission surface 2a of the first light emitting device. Here, the equation: D1=D2 is simply possible. However, more accurately, the refractive index of the prism 4 for optical coupling is taken into consideration to allow the optical path lengths to be equal to each other. That is, when the refractive index of the prism 4 for optical coupling is n, and the refractive index in the other parts (in the air) is 1, D1=nD2.

It should be noted that the distance (the dimension D1 of FIG. 5) between the emission surface 2a of the first light emitting device 2 and the emission surface 3a of the second light emitting device 3 is, for example, about 1 mm, but is not limited as such.

Next, the height of the light emitting point of each light emitting device in the optical unit 1 will be described. As shown in FIG. 3, in the optical unit 1, the height H1 of the light emitting point of the first light emitting device 2 is equal to the height H2 of the light emitting point of the second light emitting device 3. Here, as to the first light emitting device 2, the distance between the opening 26 and the opening 27 is short enough as described above to consider the height of the midpoint therebetween as the height H1 of the light emitting points. Moreover, here, the heights of the light emitting points are understood as the distance from the lower surface 40 of the optical unit 1. The lower surface 40 is a mounting surface used to mount the optical unit 1 on electronic equipment or the like.

As described above, when the height H1 of the light emitting point of the first light emitting device 2 is equal to the height H2 of the light emitting point of the second light emitting device 3, it becomes easy to make the optical axes of their beams coincident with each other. That is, when the optical axes are made coincident to each other by using, for example, the prism 4 for optical coupling, it is no longer necessary to perform adjustment in the height direction. Therefore, it may be required only that adjustment in one direction (in a direction perpendicular to the height direction, that is, here, in a direction parallel to the lower surface 40) is performed, and thus it is possible to more easily make the optical axes coincident with each other.

It should be noted that the lower surface 40 is used as a base with respect to which the heights of the light emitting points are described in the above description, but the base is not limited to the lower surface 40. Provided that the height direction is a direction perpendicular to a direction in which the optical axes are adjusted by using the prism 4 for optical coupling, the height of the light emitting point of the first light emitting device 2 may be made equal to the height of the light emitting point of the second light emitting device. As described with reference to FIG. 1, the prism 4 for optical coupling may be provided in the electronic equipment separately from the optical unit 1, or the optical unit 1b including the prism 4 for optical coupling may be used.

In this way, in the optical unit 1 including the first light emitting device 2 and the second light emitting device 3, the optical axes and the optical path lengths of the beams emitted from the light emitting devices can be easily made coincident with and equal to each other. As a result, electronic equipment supporting beams of a plurality of wavelengths can be achieved by employing one optical unit (and its associated optical system), thereby enabling the electronic equipment to be downsized.

It should be noted that in every one of a CD, a DVD, and a BD, a reflected beam from the medium 13 returns to the optical unit 1 side, and is received there by a light receiving device (not shown). This can be achieved by a conventional configuration, and thus detailed illustration and description thereof are omitted.

Next, an image formed by a beam supplied to the medium 13 will be described. FIG. 6 is a view showing the medium 13 and an image formed thereon by a beam.

The medium 13 includes tracks 29 in which signals are recorded, and lands 30 separating the neighboring tracks 29 from each other.

In the tracks 29, circles 31a each represent a “1” signal, and ellipses 31b each represent a series of “1” signals written thereto. Moreover, spots without circles 31a and ellipses 31b each represent a “0” signal, and areas without circles and ellipses over a long extent each represent a series of “0” signals.

In the optical unit 1 of the present embodiment, beams emitted from the first light emitting device 2 and the second light emitting device 3 each form, on the medium 13, an elliptical image which is oblique with respect to the track 29. Such an image is denoted by reference character A. One of the causes that the elliptical image A is oblique is that the first light emitting device 2 and the second light emitting device 3 are both arranged on the inclined plane 17 and the inclined plane 18 of the triangular-prism-shaped mount 15. Moreover, if other members are additionally arranged in the optical system, the Fourier transform operation may have influence.

The fact that the image A is obliquely formed as described above shows the advantage of preventing errors such as the occurrence of crosstalk between the tracks 29. This will be described below.

First, the case where, as an image B, an elliptical image elongated in a direction parallel to the track 29 is formed on the medium 13 is considered. In this case, a beam may fall on, in addition to a targeted predetermined signal, other neighboring signals of the predetermined signal in the same track 29. This may hinder accurate reading.

Moreover, the case where, as an image C, an elliptical image elongated in a direction perpendicular to the track 29 is formed is considered. In this case, a beam may fall on a targeted track and also other neighboring tracks 29 of the targeted track. Also in such a case, the accurate reading may be hindered.

In contrast to the above cases, in the present embodiment, the elliptical image A which is oblique with respect to the track 29 is formed. Therefore, there is no possibility of reading neighboring signals in the same track 29. Moreover, between the neighboring tracks 29, a margin as long as the distance d is allowed, so that there is no possibility of reading signals of the neighboring tracks 29.

In this way, obliquely forming the image A achieves the advantage of accurate reading without errors. It should be noted that although the case of reading is described above, forming the oblique image A likewise achieves accurate writing also in writing data.

It should be noted that to obtain the above-mentioned advantage more reliably, the major axis of the elliptical image A forms desirably an angle of greater than or equal to 20° and less than or equal to 50°, and more desirably an angle of greater than or equal to 30° and less than or equal to 50° with respect to the track 29. For this purpose, in FIG. 4, the inclined plane 17 and the inclined plane 18 each forms an angle of 30° to 45° with respect to an upper surface of the heat dissipation plate 14.

Moreover, a method for obtaining the oblique image A is not limited to using the optical unit 1 of FIG. 2. For example, any one of the example optical units described below may be used, or other methods may be possible. It may be required only that electronic equipment including an optical unit is configured to allow a beam to obliquely form an image on a track of a medium. This can be easily achieved by obliquely disposing a light emitting device on the optical unit.

### Other Examples

In the case of the optical unit 1 shown in FIG. 2 and the like, the triangular-prism-shaped mount 15 is used, and the light emitting devices are mounted on two of the inclined planes of the triangular-prism-shaped mount 15. However, such a configuration is not essential. Hereinafter, other examples of the present embodiment will be described with reference to the drawings.

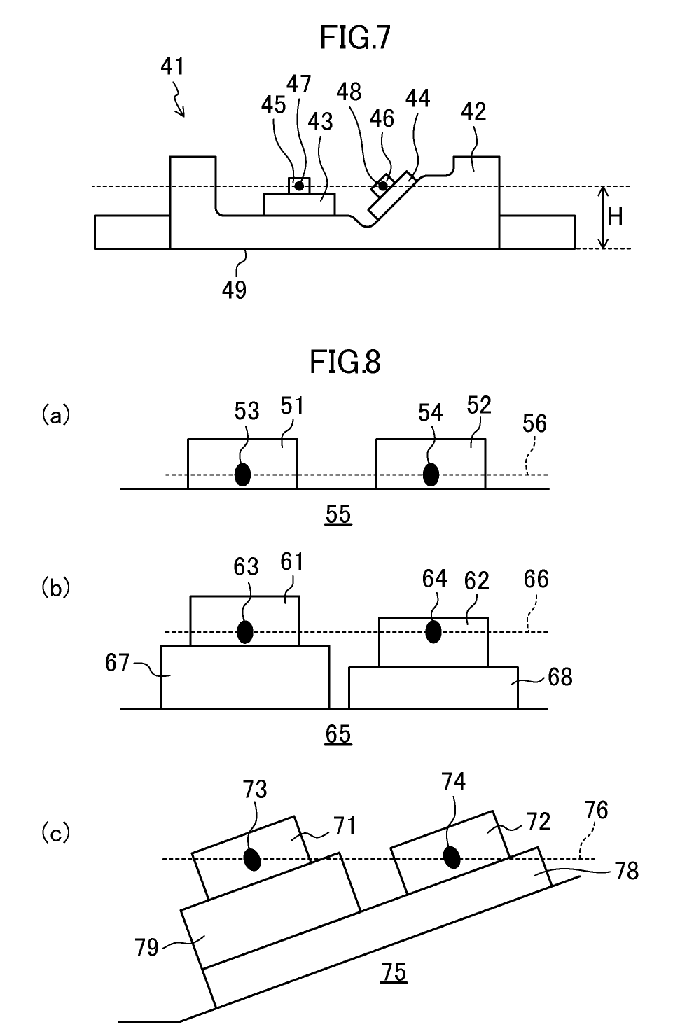

FIG. 7 is a view schematically showing an example optical unit 41. As in FIG. 3, the example optical unit 41 of FIG. 7 is viewed in a light emission direction (where components important for description are shown, and some components are omitted). The optical unit 41 includes, on a seat 42, a first light emitting device 45 mounted on a submount 43, and a second light emitting device 46 mounted on a submount 44. Here, part of an upper surface of the seat 42 is oblique with respect to a lower surface 49 of the optical unit 41, and the submount 44 and the second light emitting device 46 are mounted on the oblique part. As a result, the second light emitting device 46 is mounted obliquely with respect to the optical unit 41, and thus a beam emitted from the second light emitting device 46 can form an elliptical image which is oblique with respect to a track of a medium, for example, a CD. In this way, as described with reference to FIG. 6, it is possible to improve the quality of recording and reproduction.

Moreover, in the optical unit 41, a light emitting point 47 of the first light emitting device 45 and a light emitting point 48 of the second light emitting device 46 are equal in height H of the light emitting points. Here, the height H of the light emitting points is understood as a distance from the lower surface 49 of the optical unit 41 respectively to the light emitting point 47 and the light emitting point 48.

Therefore, to make optical axes of beams emitted from the light emitting point 47 and the light emitting point 48 coincident with each other, it may be required only that the optical axes are adjusted only in one direction (here, in a direction parallel to the lower surface 49).

Moreover, in the optical unit 41 of FIG. 7, only the second light emitting device 46 is obliquely mounted. However, it is of course possible that also the first light emitting device 45 is mounted on the oblique part of the upper surface of the seat 42. In this way, also a beam emitted from the first light emitting device 45 can form an image obliquely with respect to a track of a medium, thereby improving the quality of recording and reproduction.

Although an example in which the second light emitting device 46 is oblique with respect to the lower surface 49 is shown, another base in the optical unit 41 may be possible.

Next, in FIGS. 8A through 8C, other examples of disposition of light emitting devices are further shown.

In FIG. 8A, a light emitting point 53 of a first light emitting device 51 and a light emitting point 54 of a second light emitting device 52 have substantially the same distance from a surface on which the light emitting devices are mounted. In this case, simply mounting the first light emitting device 51 and the second light emitting device 52 on a submount 55 allows the same height 56 of the light emitting points.

In FIG. 8B, a light emitting point 63 of a first light emitting device 61 and a light emitting point 64 of a second light emitting device 62 have different distances from surfaces on which the light emitting devices are respectively mounted. For example, this is the case where one of the light emitting devices is mounted in a junction-up manner, and the other is mounted in a junction-down manner. In such a case, a submount 67 on which the first light emitting device 61 is mounted and a submount 68 on which the second light emitting device 62 is mounted are made different in thickness in order to make the distances from a seat 65 on which the submounts are mounted to the respective light emitting points equal to each other. In this way, the first light emitting device 61 and the second light emitting device 62 can have the same height 66 of the light emitting points.

In FIG. 8C, a first light emitting device 71 and a second light emitting device 72 are mounted above an oblique part of an upper surface of a seat 75. Here, the second light emitting device 72 is directly mounted on a submount 78, whereas the first light emitting device 71 is mounted on a submount 79, which is provided on the submount 78. In this way, the two light emitting devices are both obliquely mounted, and a light emitting point 73 of the first light emitting device 71 and a light emitting point 74 of the second light emitting device 72 have the same height 76 of the light emitting points.

Alternatively, it is also possible, for example, to prepare two triangular-prism-shaped mounts, on which light emitting devices are respectively mounted. Also in this case, it is possible to make the heights of the light emitting points equal to each other, and to obliquely mount the light emitting devices.

Moreover, also in the example optical units described above, for correcting the difference between the optical path lengths caused to adjust the optical axes, an emission surface of one of the light emitting devices may be set back from an emission surface of the other light emitting device as in FIG. 5.

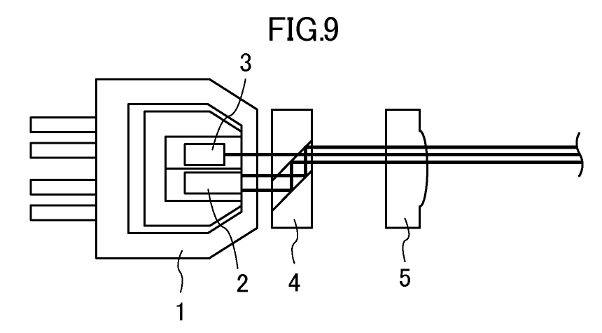

Moreover, electronic equipment including one of the optical units described above may be provided with a relay lens. In FIG. 9, it is shown that beams emitted from an optical unit 1 pass through a prism 4 for optical coupling, and then pass through a relay lens 5. After that, as in FIG. 1, the beams pass through an aberration correcting lens, and the like to be led to a medium 13.

The above-described optical unit and the electronic equipment including the same achieve downsizing of equipment configured to emit beams of a plurality of wavelengths, specifically of a plurality of wavelength supporting CDs, DVDs and BDs, and improve the quality of recording and reproduction of the media. Therefore, the optical unit and the electronic equipment including the same are useful in various kinds of optical electronic equipment in further advanced stages of downsizing.

What is claimed is:

1. An optical unit comprising:
a first light emitting device configured to emit a first beam; and
a second light emitting device configured to emit a second beam in a direction the same as a direction of the first beam where the second beam is different in wavelength from the first beam, wherein
an emission surface of the second light emitting device is arranged at a predetermined distance from an emission surface of the first light emitting device in an opposite direction to the direction of the first beam.

2. The optical unit of claim 1, wherein the predetermined distance is set in accordance with a distance between a light emitting point of the first light emitting device and a light emitting point of the second light emitting device.

3. The optical unit of claim 1, further comprising:
a prism for optical coupling to make an optical axis of the first beam and an optical axis of the second beam coincident with each other,
wherein the predetermined distance is set such that an optical path length for the first beam to arrive at a point where the first beam is output from the prism for optical coupling is substantially equal to an optical path length for the second beam to arrive at a point where the second beam is output from the prism for optical coupling.

4. The optical unit of claim 1, wherein a height of a light emitting point of the first light emitting device is equal to a height of a light emitting point of the second light emitting device.

5. The optical unit of claim 1, wherein at least one of the first light emitting device and the second light emitting device is mounted obliquely with respect to a predetermined base plane of the optical unit.

6. The optical unit of claim 4, wherein at least one of the first light emitting device and the second light emitting device is mounted obliquely with respect to a predetermined base plane of the optical unit.

7. The optical unit of claim 1, further comprising:
a mount at least having a first inclined plane and a second inclined plane,
wherein the first light emitting device is provided on the first inclined plane of the mount, and the second light emitting device is provided on the second inclined plane of the mount.

8. The optical unit of claim 7, wherein
the mount is of triangular-prism shape, and
one of three side surfaces of the triangular-prism-shaped mount is a body attachment surface, and the other two side surfaces are the first inclined plane and the second inclined plane.

9. The optical unit of claim 8, wherein
the triangular-prism-shaped mount has a fourth side surface as if at least part of a ridge formed by the meeting of the first inclined plane and the second inclined plane is removed, and
the fourth side surface is a ground connection surface.

10. The optical unit of claim 1, wherein the first light emitting device selectively emits beams of two wavelengths.

11. The optical unit of claim 10, wherein the first light emitting device emits a beam for CD and a beam for DVD.

12. The optical unit of claim 1, wherein the second light emitting device output a beam for BD.

13. Electronic equipment comprising:
the optical unit of claim 1;
a first objective lens for the first light emitting device; and
a second objective lens for the second light emitting device,
wherein the first objective lens and the second objective lens are provided in a light emission direction of the optical unit.

14. The electronic equipment of claim 13, further comprising a prism for optical coupling to make an optical axis of the first beam and an optical axis of the second beam coincident with each other.

15. The electronic equipment of claim 13, further comprising a relay lens provided in the light emission direction of the optical unit.

16. The electronic equipment of claim 13, further comprising an aberration correcting lens between the relay lens and the first and second objective lenses.

17. The electronic equipment of claim 13, wherein at least one of the first beam passed through the first objective lens and the second beam passed through the second objective lens forms an image obliquely with respect to a track of a media arranged to face the first objective lens and the second objective lens.

18. An optical unit for reading information from or writing information to a medium including tracks in which signals are recorded and lands separating neighboring tracks from each other, the optical unit comprising:
a first light emitting device configured to emit a first beam;
a second light emitting device configured to emit a second beam in a direction the same as a direction of the first beam where the second beam is different in wavelength from the first beam; and
a prism configured to coincide optical axes of the first and second beams at an output portion of the optical unit, wherein
an emission surface of the second light emitting device is arranged at a predetermined distance from an emission surface of the first light emitting device in an opposite direction to the direction of the first beam so that an optical path length from the emission surface of the first light emitting device to the output portion of the prism is substantially equal to an optical path length from the emission surface of the second light emitting device to the output portion of the prism.

19. The optical unit of claim 18, wherein
the first and second light emitting device are mounted on first and second surfaces of a mount, and
at least one of the first and second surfaces of the mount is inclined at an angle with respect to a predetermined base plane of the optical unit so that the one of the first and second light emitting devices mounted thereon to form, on the medium, an elliptical image which is oblique with respect to one of the tracks to thereby eliminate the occurrence of crosstalk between the one of the tracks and a neighboring track.

20. The optical unit of claim 1, wherein the first and second light emitting devices are mounted on a mount with another predetermined distance therebetween that is less than or equal to 1000 μm.
